(19) United States
(12) Patent Application Publication
(10) Pub. No.: US 2010/0149740 A1
(43) Pub. Date: Jun. 17, 2010

(54) SHAPE-CHANGEABLE GAMING CONTROLLER

(75) Inventor: Yu-Chih Cheng, Taipei (TW)

Correspondence Address: KIRTON AND MCCONKIE, 60 EAST SOUTH TEMPLE,, SUITE 1800, SALT LAKE CITY, UT, 84111, US

(73) Assignee: PRIMAX ELECTRONICS LTD., Taipei (TW)

(21) Appl. No.: 12/370,324

(22) Filed: Feb. 12, 2009

(30) Foreign Application Priority Data
Dec. 12, 2008 (TW) 097148374

(51) Int. Cl. G06F 1/16

(52) U.S. Cl. 361/679.4

(57) ABSTRACT

A shape-changeable gaming controller includes an operating part, a first holding part, a second holding part, a triggering part, a first connecting element and a second connecting element. The first connecting element is arranged between the first holding part and the operating part for connecting the first holding part and the operating part. The second connecting element is arranged between the second holding part and the operating part for connecting the second holding part and the operating part. The first holding part and the second holding part are rotatable with respect to the operating part so as to change the shape of the gaming controller.

### FIELD OF THE INVENTION

The present invention relates to a controller, and more particularly to a gaming controller for playing computer games.

### BACKGROUND OF THE INVENTION

With rapid development of electronic and information industries, computers and the peripheral device thereof become essential parts in our daily lives. In addition to the working purposes, computers can be employed as amusement tools. For example, computers are widely used for playing multimedia files such as songs or movies. Moreover, by installing game software (e.g. online game software) in a computer, the user may play online games over the computer.

Conventionally, the game software is written into a game cartridge or a compact disc and then executed in an exclusive game console. An example of the exclusive game console includes the early-stage Nintendo game console, the widely favorable PlayStation game console (PS1, PS2 or PS3), and the recently marketable Wii console. Since computers have gained popularity, the computer manufacturers make efforts in designing novel computers having enhanced amusement efficacy but without the need of purchasing the exclusive game consoles. For increasing competition in the market, the hardware components and the software components for playing games over the computers are increasingly improved. The subject of the present invention is directed to a gaming controller for use with computer game software.

Conventionally, a keyboard and a mouse are used to play computer games. Since the use of the keyboard or the mouse to play computer games is very distinguished from the use of the gaming controller of the exclusive game console, the keyboard or the mouse is not easy-to-use and usually becomes hindrance from playing the computer games. For solving these drawbacks, a gaming controller for playing computer games has been disclosed.

FIG. 1 is a schematic perspective view of a conventional gaming controller. As shown in FIG. 1, the gaming controller 1 includes a housing 10, various control buttons 11, 12, and two control sticks 13. The control button 12 is a direction button that is operated to set a direction to move a character or cursor. When the control buttons 11 are depressed, corresponding instructions are executed. The control stick 13 is a popular variation of a joystick. By operating the control sticks 13, the object shown on the computer screen may be moved in various directions, especially the 45-degree directions. In views of user-friendliness and convenience, the gaming controller 1 is feasible for playing computer games.

With the maturity of game software industries, diverse game software types have been published. Especially, some manipulative racing games (e.g. car racing games, gun shooting games, flight simulation games or ball racing games) are very pleasing to most users. For playing diverse racing games, the users needs to purchase corresponding gaming controller so to enhance their manipulative properties. For example, a steering wheel controller, a pistol controller and a racket controller are respectively selected when the user plays the car racing games, the gun shooting games and the ball racing games. A commercially available racket controller for playing ball racing games is a Nintendo Wii controller, which is designed to have a wand shape. The wand-like Nintendo Wii controller is used to mimic the motions of a tennis racket or a baseball bat. When such a controller is held by the palm of the user, the user may swing the controller to play the ball racing games. The wand-like gaming controller, however, fails to be used to play car racing games or gun shooting games. For playing car racing games, gun shooting games, the user needs to additionally purchase a steering wheel controller or a pistol controller. It is not cost-effective to simultaneously purchase too many gaming controllers. In addition, too many gaming controllers occupy much space for storage.

Therefore, there is a need of providing a shape-changeable and multi-functional gaming controller to obviate the drawbacks encountered from the prior art.

### SUMMARY OF THE INVENTION

It is an object of the present invention to provide a shape-changeable gaming controller.

Another object of the present invention provides a multi-functional gaming controller.

In accordance with an aspect of the present invention, there is provided a shape-changeable gaming controller for use with game software of a computer. The shape-changeable gaming controller includes a first holding part, a second holding part, an operating part, a triggering part, a first connecting element and a second connecting element. The first holding part has a first inclined surface and a first opening. The second holding part has a second inclined surface and a second opening. The operating part is arranged between the first holding part and the second holding part. The operating part includes a first operating part inclined surface, a second operating part inclined surface, a first operating part opening and a second operating part opening. The triggering part is disposed on the operating part, wherein an instruction is generated when the triggering part is depressed. The first connecting element is arranged between the first holding part and the operating part. The first connecting element is embedded into and engaged with the first opening and the first operating part opening, so that the first holding part and the operating part are combined together via the first connecting element and the first inclined surface is contacted with the first operating part inclined surface. The second connecting element is arranged between the second holding part and the operating part. The second connecting element is embedded into and engaged with the second opening and the second operating part opening, so that the second holding part and the operating part are combined together via the second connecting element and the second inclined surface is contacted with the second operating part inclined surface. The first holding part and the second holding part are rotatable with respect to the operating part. A first included angle is formed between the first holding part and the operating part when the first holding part is rotated with respect to the operating part. A second included angle is formed between the second holding part and the operating part when the second holding part is rotated with respect to the operating part.

In an embodiment, the operating part further includes multiple control buttons, wherein corresponding instructions are generated when the control buttons are depressed.

In an embodiment, the shape-changeable gaming controller further includes a wireless signal emitter for emitting a wireless signal.

In an embodiment, a wireless signal receiver is connected with the computer for receiving the wireless signal. The instructions generated when the triggering part and the control buttons are depressed are transmitted to the computer by the wireless signal.

In an embodiment, the first holding part further includes a battery receptacle for accommodating a battery so as to provide electricity.

In an embodiment, the first holding part further includes a first anti-slip part for providing a frictional surface to facilitate holding the first holding part.

In an embodiment, the second holding part further includes a second anti-slip part for providing a frictional surface to facilitate holding the second holding part.

In an embodiment, the first connecting element is a hinge.

In an embodiment, the second connecting element is a hinge.

The above objects and advantages of the present invention will become more readily apparent to those ordinarily skilled in the art after reviewing the following detailed description and accompanying drawings, in which:

### BRIEF DESCRIPTION OF THE DRAWINGS

FIG. 1 is a schematic perspective view of a conventional gaming controller;

FIG. 2 is a shape-changeable gaming controller for use with a computer system according to the present invention;

FIG. 3A is a schematic exploded view illustrating a shape-changeable gaming controller according to a preferred embodiment of the present invention;

FIG. 3B is a schematic exploded view illustrating the shape-changeable gaming controller according to the preferred embodiment of the present invention and take from a different viewpoint;

FIG. 4 is a schematic assembled view illustrating the shape-changeable gaming controller according to the preferred embodiment of the present invention;

FIG. 5 is a schematic perspective view illustrating the shape-changeable gaming controller of the present invention in a shooting mode; and

FIG. 6 is a schematic perspective view illustrating the shape-changeable gaming controller of the present invention in a steering wheel mode.

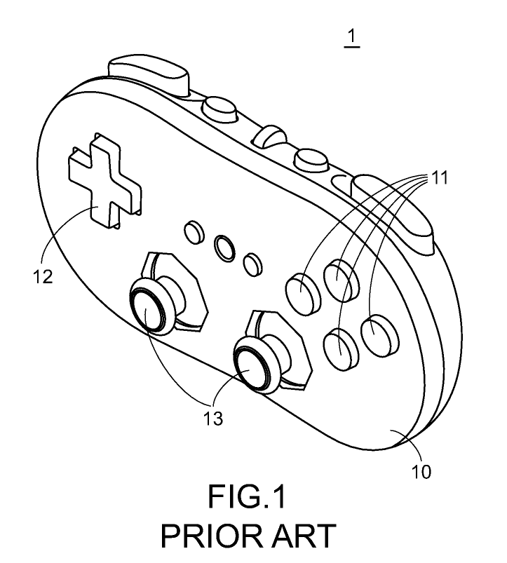

### DETAILED DESCRIPTION OF THE PREFERRED EMBODIMENT

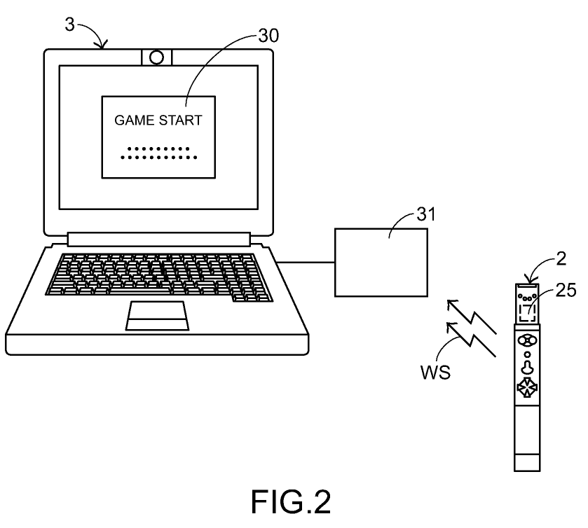

For meeting the market demand, the present invention relates to a multi-functional and shape-changeable gaming controller. FIG. 2 is a shape-changeable gaming controller for use with a computer system according to the present invention. In the computer system of FIG. 2, specified game software 30 is executed in a computer 3. The computer 3 is connected to a wireless signal receiver 31. The shape-changeable gaming controller 2 comprises a wireless signal emitter 25 for emitting a wireless signal WS. The wireless signal WS is transmitted from the wireless signal emitter 25 to the wireless signal receiver 31 according to a wireless transmission technology. The wireless signal WS is then transmitted from the wireless signal receiver 31 to the computer 3. According to the wireless signal WS, the computer 3 executes a corresponding instruction.

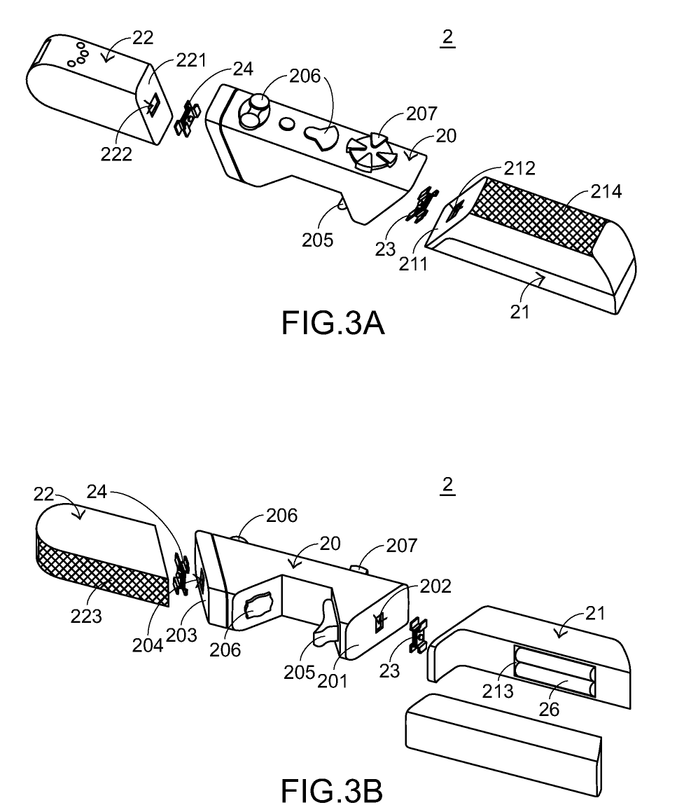

Hereinafter, the configurations of the shape-changeable gaming controller of the present invention will be illustrated in more details with reference to FIGS. 3A and 3B. FIG. 3A is a schematic exploded view illustrating a shape-changeable gaming controller according to a preferred embodiment of the present invention. FIG. 3B is a schematic exploded view illustrating the shape-changeable gaming controller according to the preferred embodiment of the present invention and take from a different viewpoint. The shape-changeable gaming controller 2 principally comprises an operating part 20, a first holding part 21, a second holding part 22, a triggering part 205, a first connecting element 23 and a second connecting element 24. The first holding part 21 has a first inclined surface 211, a first opening 212, a first anti-slip part 214 and a battery receptacle 213. The battery receptacle 213 is used for accommodating a battery 26. The battery 26 can provide electricity required for operations of the shape-changeable gaming controller 2. The second holding part 22 has a second inclined surface 221, a second opening 222 and a second anti-slip part 223. The operating part 20 comprises a first operating part inclined surface 201, a second operating part inclined surface 203, a first operating part opening 202, a second operating part opening 204 and multiple control buttons 206 (including a direction button 207). When the control buttons 206 are depressed, corresponding instructions are generated. The direction button 207 is operated to set a direction to move a character or cursor. The triggering part 205 is disposed on the operating part 20. When the triggering part 205 is depressed, a specified instruction is generated. In this embodiment, the first connecting element 23 and the second connecting element 24 are hinges.

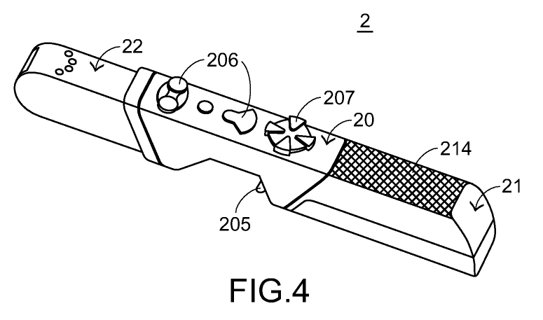

FIG. 4 is a schematic assembled view illustrating the shape-changeable gaming controller according to the preferred embodiment of the present invention. Please refer to FIGS. 3A, 3B and 4. The operating part 20 is arranged between the first holding part 21 and the second holding part 22. The first connecting element 23 is arranged between the first holding part 21 and the operating part 20. The second connecting element 24 is arranged between the second holding part 22 and the operating part 20. The first connecting element 23 is embedded into and engaged with the first opening 212 and the first operating part opening 202, so that the first holding part 21 and the operating part 20 are combined together via the first connecting element 23 and the first inclined surface 211 is contacted with the first operating part inclined surface 201. The second connecting element 24 is embedded into and engaged with the second opening 222 and the second operating part opening 204, so that the second holding part 22 and the operating part 20 are combined together via the second connecting element 24 and the second inclined surface 221 is contacted with the second operating part inclined surface 203. In accordance with a key feature of the present invention, the first holding part 21 and the second holding part 22 are rotatable with respect to the operating part 20 so as to change the shape of the gaming controller 2.

As shown in FIG. 4, the gaming controller 2 has a wand shape in a normal mode. In a case that the user intends to play a ball racing game, the user may grasp the wand-shaped gaming controller 2 and swing the gaming controller 2 to mimic the motions of a ball sport and input a corresponding instruction. In another case that the user intends to play a gun shooting game, the first holding part 21 is rotated with respect to the operating part 20 by 180 degrees such that the shape-changeable gaming controller 2 is operated in a shooing mode. Meanwhile, as shown in FIG. 5, the outward appearance of the shape-changeable gaming controller 2 is changed from the wand-shape structure of a racket controller to the gun-shaped structure of a pistol controller. Under this circumstance, a first included angle al is defined between the first holding part 21 and the operating part 20 while the first inclined surface 211 is still contacted with the first operating part inclined surface 201. In this shooting mode, the user may depress the triggering part 205 to mimic the shooting action. The outward appearance of the shape-changeable gaming controller 2 in the shooting mode is shown in FIG. 5.

Moreover, the first holding part 21 of the gaming controller 2 further comprises a first anti-slip part 214. The first anti-slip part 214 can provide a frictional surface to facilitate the user's hand to hold the first holding part 21 so as to prevent the first holding part 21 from being slipped off the user's hand.

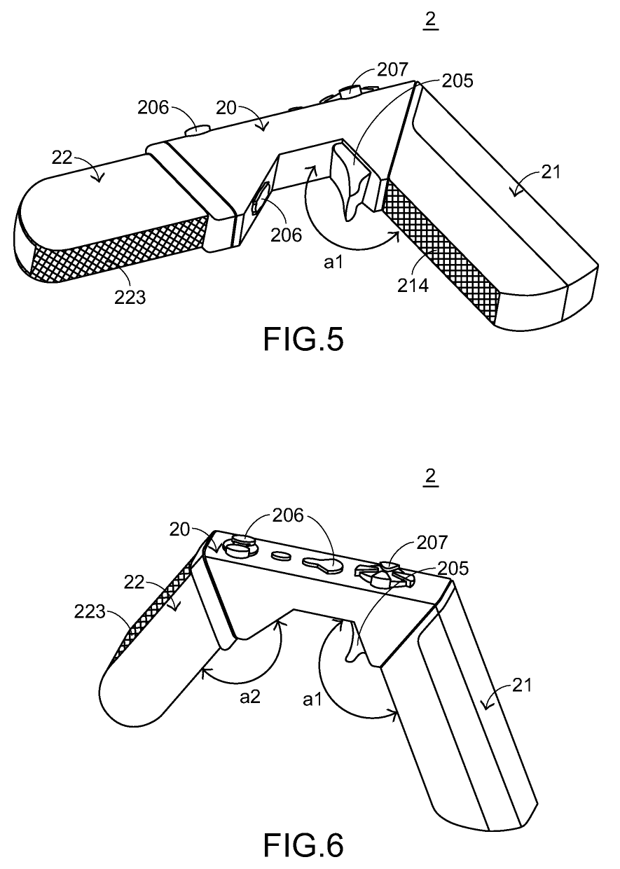

FIG. 6 is a schematic perspective view illustrating the shape-changeable gaming controller of the present invention in a steering wheel mode. After the shape-changeable gaming controller 2 is operated in the shooing mode, the second holding part 22 can be rotated with respect to the operating part 20 by 180 degrees, so that the operating mode of the shape-changeable gaming controller 2 is switched from the shooing mode steering wheel mode. That is, the outward appearance of the shape-changeable gaming controller 2 is changed from the gun-shaped structure of a pistol controller to the structure of a steering wheel controller. Under this circumstance, a first included angle al is defined between the first holding part 21 and the operating part 20 and a second included angle a2 is defined between the second holding part 22 and the operating part 20 while the second inclined surface 221 is still contacted with the second operating part inclined surface 203.

Moreover, the second holding part 22 of the gaming controller 2 further comprises a second anti-slip part 223. The second anti-slip part 223 can provide a frictional surface to facilitate the user's hand to hold the second holding part 22 so as to prevent the second holding part 22 from being slipped off the user's hand.

From the above description, the structures and the functions of a steering wheel controller, a pistol controller and a racket controller are integrated into the shape-changeable gaming controller of the present invention. By simply rotating the first holding part and/or the second holding part with respect to the operating part, the operating mode of the shape-changeable gaming controller is changeable. In other words, the user may purchase only one gaming controller of the present invention to achieve the structures and the functions of three different controllers. In addition, since the space for storing only one gaming controller is less than that for storing three different controllers, the drawback encountered from the prior art is obviated.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A shape-changeable gaming controller for use with game software of a computer, said shape-changeable gaming controller comprising:
a first holding part having a first inclined surface and a first opening;
a second holding part having a second inclined surface and a second opening;
an operating part arranged between said first holding part and said second holding part, and comprising a first operating part inclined surface, a second operating part inclined surface, a first operating part opening and a second operating part opening;
a triggering part disposed on said operating part, wherein an instruction is generated when said triggering part is depressed;
a first connecting element arranged between said first holding part and said operating part, wherein said first connecting element is embedded into and engaged with said first opening and said first operating part opening, so that said first holding part and said operating part are combined together via said first connecting element and said first inclined surface is contacted with said first operating part inclined surface;
a second connecting element arranged between said second holding part and said operating part, wherein said second connecting element is embedded into and engaged with said second opening and said second operating part opening, so that said second holding part and said operating part are combined together via said second connecting element and said second inclined surface is contacted with said second operating part inclined surface,
wherein said first holding part and said second holding part are rotatable with respect to said operating part, a first included angle is formed between said first holding part and said operating part when said first holding part is rotated with respect to said operating part, and a second included angle is formed between said second holding part and said operating part when said second holding part is rotated with respect to said operating part.

2. The shape-changeable gaming controller according to claim 1 wherein said operating part further comprises multiple control buttons, and corresponding instructions are generated when said control buttons are depressed.

3. The shape-changeable gaming controller according to claim 2 further comprising a wireless signal emitter for emitting a wireless signal.

4. The shape-changeable gaming controller according to claim 3 wherein a wireless signal receiver is connected with said computer for receiving said wireless signal, and said instructions generated when said triggering part and said control buttons are depressed are transmitted to said computer by said wireless signal.

5. The shape-changeable gaming controller according to claim 1 wherein said first holding part further comprises a battery receptacle for accommodating a battery so as to provide electricity.

6. The shape-changeable gaming controller according to claim 1 wherein said first holding part further comprises a first anti-slip part for providing a frictional surface to facilitate holding said first holding part.

7. The shape-changeable gaming controller according to claim 1 wherein said second holding part further comprises a second anti-slip part for providing a frictional surface to facilitate holding said second holding part.

8. The shape-changeable gaming controller according to claim 1 wherein said first connecting element is a hinge.

9. The shape-changeable gaming controller according to claim 1 wherein said second connecting element is a hinge.
